(19) United States
(12) Patent Application Publication
(10) Pub. No.: US 2011/0109795 A1
(43) Pub. Date: May 12, 2011

(54) IMAGE PROCESSING APPARATUS AND IMAGE PROCESSING METHOD

(75) Inventors: Kohei Inamura, Sagamihara-shi (JP); Taisuke Nishio, Tokyo (JP)

(73) Assignee: CANON KABUSHIKI KAISHA, Tokyo (JP)

(21) Appl. No.: 12/940,652

(22) Filed: Nov. 5, 2010

(30) Foreign Application Priority Data
Nov. 10, 2009 (JP) 2009-256882

(51) Int. Cl. H04N 7/01

(52) U.S. Cl. 348/441; 348/E07.003

(57) ABSTRACT

An image processing apparatus includes: motion vector detecting unit which divides an input video image into a plurality of blocks and detects a motion vector of each of the blocks; telop detecting unit which detects a horizontal telop and a vertical telop from the input video image; first correcting unit which corrects the motion vector of a block that includes the horizontal telop; second correcting unit which corrects the motion vector of a block that includes the vertical telop; control unit which controls the first and second correcting units such that when the horizontal and vertical telops are detected, correction is performed by one of the first and second correcting units, and correction by the other one of the first and second correcting units is omitted; and generating unit which generates the interpolated frame, using the motion vector of each of the blocks.

### BACKGROUND OF THE INVENTION

1. Field of the Invention

The present invention relates to an image processing apparatus and an image processing method.

2. Description of the Related Art

Recent years have witnessed advancements in research and development into frame rate conversion techniques for increasing a frame count by performing frame interpolation in order to improve a moving image resolution (an index representing a moving image performance) during display of a moving image (video image). Further, character strings that scroll over a screen, i.e. so-called telops or scrolling tickers, are regions to which a viewer of a display apparatus pays particular attention, and therefore a favorable effect can be expected when a frame rate conversion technique is employed to depict telop movement smoothly.

A technique for depicting telop movement smoothly is disclosed in Japanese Patent Application Publication No. 2009-042897, for example. More specifically, in the technique disclosed in Japanese Patent Application Publication No. 2009-042897, an image is divided into blocks arranged in lattice form, and a motion vector of a telop is detected from a motion vector determined in each block. The motion vector of a block in which a telop is highly likely to exist is then replaced by the motion vector of the detected telop (motion vector correction processing). By generating an interpolated frame using the motion vector of the detected telop as the motion vector of the block in which the telop is highly likely to exist, telop movement can be depicted smoothly.

However, with the technique disclosed in Japanese Patent Application Publication No. 2009-042897, a problem arises when a video image includes a telop moving in a horizontal direction (a horizontal telop) and a telop moving in a vertical direction (a vertical telop). More specifically, with the technique disclosed in Japanese Patent Application Publication No. 2009-042897, the motion vector correction processing is performed in such a case on all of the blocks in which the respective telops are highly likely to exist, leading to an increase in a processing load. Further, a calculation processing apparatus having great computing power must be used to complete this processing within a single frame period, leading to an increase in cost.

### SUMMARY OF THE INVENTION

The present invention provides a technique with which telop movement can be depicted smoothly using a simple constitution.

An image processing apparatus for converting a frame rate by inserting an interpolated frame between frames of an input video image, according to the present invention, comprises:

motion vector detecting unit which divides the input video image into a plurality of blocks and detects a motion vector of each of the blocks;

telop detecting unit which detects a horizontal telop that moves in a horizontal direction and a vertical telop that moves in a vertical direction from the input video image;

first correcting unit which corrects the motion vector of a block that includes the horizontal telop, from among the plurality of blocks;

second correcting unit which corrects the motion vector of a block that includes the vertical telop, from among the plurality of blocks;

control unit which controls the first correcting unit and the second correcting unit on the basis of a detection result from the telop detecting unit; and

generating unit which generates the interpolated frame, using the motion vector of each of the blocks,

wherein, when the telop detecting unit detects both the horizontal telop and the vertical telop, the control unit controls the first correcting unit and the second correcting unit such that correction is performed by one of the first correcting unit and the second correcting unit and correction by the other one of the first correcting unit and the second correcting unit is omitted.

An image processing method for converting a frame rate by inserting an interpolated frame between frames of an input video image, according to the present invention, comprises:

a motion vector detecting step of dividing the input video image into a plurality of blocks and detecting a motion vector of each of the blocks;

a telop detecting step of detecting a horizontal telop that moves in a horizontal direction and a vertical telop that moves in a vertical direction from the input video image;

a first correcting step of correcting the motion vector of a block that includes the horizontal telop, from among the plurality of blocks;

a second correcting step of correcting the motion vector of a block that includes the vertical telop, from among the plurality of blocks;

a control step of controlling processing performed in the first correcting step and the second correcting step on the basis of a detection result from the telop detecting step; and

a generating step of generating the interpolated frame, using the motion vector of each of the blocks,

wherein, when both the horizontal telop and the vertical telop are detected in the telop detecting step, the processing performed in the first correcting step and the second correcting step is controlled in the control step such that correction is performed in one of the first correcting step and the second correcting step, and correction is omitted in the other one of the first correcting step and the second correcting step.

According to the present invention, telop movement can be depicted smoothly using a simple constitution.

Further features of the present invention will become apparent from the following description of exemplary embodiments with reference to the attached drawings.

### BRIEF DESCRIPTION OF THE DRAWINGS

FIG. 1 is a block diagram showing the functional constitution of an image processing apparatus according to a first embodiment.

### DESCRIPTION OF THE EMBODIMENTS

An image processing apparatus and an image processing method according to embodiments of the present invention will be described below. The image processing apparatus according to the following embodiments converts a frame rate by inserting an interpolated frame between frames of an input video image.

### First Embodiment

### Overall Constitution

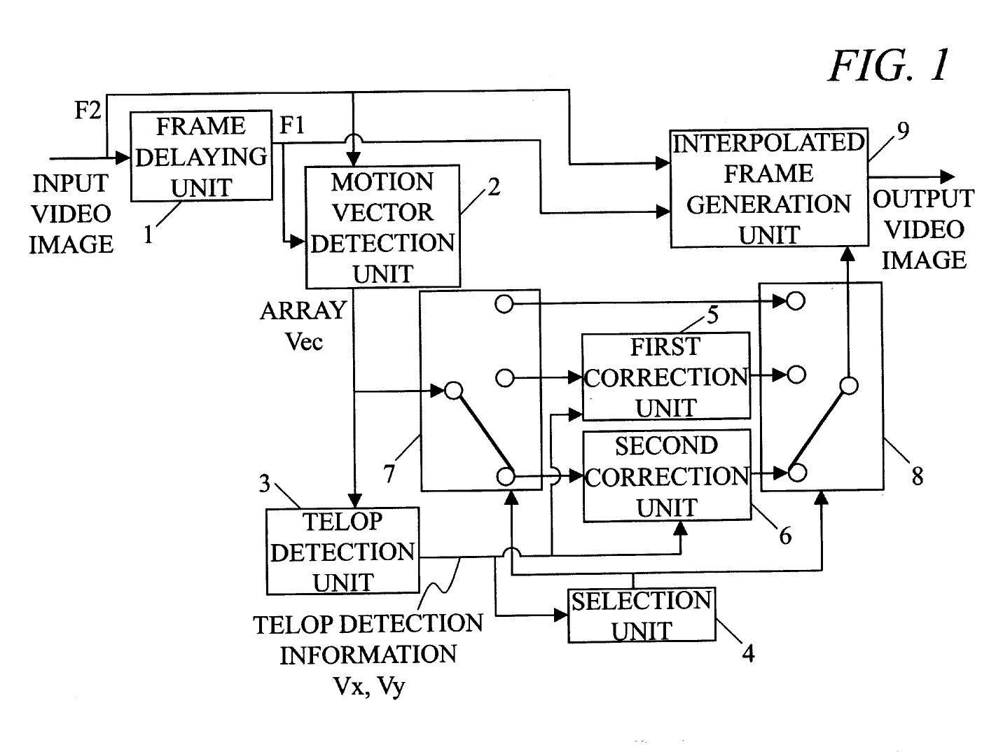

FIG. 1 is a block diagram showing the functional constitution of an image processing apparatus according to the first embodiment of the present invention. In FIG. 1, a reference numeral 1 denotes a frame delaying unit, a reference numeral 2 denotes a motion vector detection unit, a reference numeral 3 denotes a telop detection unit, a reference numeral 4 denotes a selection unit, a reference numeral 5 denotes a first correction unit, a reference numeral 6 denotes a second correction unit, 7 and 8 denote switches, and 9 denotes an interpolated frame generation unit.

An input video image (video signal) is delayed by a single frame period in the frame delaying unit 1. Note that in this embodiment, it is assumed that the video image is input in frame units.

The motion vector detection unit 2 divides the input video image into a plurality of blocks and detects a motion vector of each block. In this embodiment, the motion vector of each block (a motion vector between frames F1 and F2) is detected from a delayed frame F1 and a non-delayed frame F2 (one frame after the frame F1) using a block matching method. More specifically, an image of the frame F1 is divided into blocks arranged in lattice form, and a position on an image of the frame F2 to which each block moves is calculated by calculating a correlation value. The motion vector includes a horizontal direction component and a vertical direction component.

The motion vector detection unit 2 then outputs an array Vec of the motion vectors (detected motion vectors) corresponding to a single screen (a single frame). The array Vec is a two-dimensional array having a number of elements (motion vectors) corresponding to the number of horizontal direction blocks×the number of vertical direction blocks. The array Vec is input into the telop detection unit 3.

The telop detection unit 3 detects a telop moving in a horizontal direction (a horizontal telop) and a telop moving in a vertical direction (a vertical telop) from the input video image. In this embodiment, the presence of a horizontal telop and a vertical telop and a speed of each telop are detected by analyzing the array Vec obtained from the motion vector detection unit 2 statistically.

More specifically, a histogram of the horizontal direction component, or in other words the horizontal direction speed, is generated in relation to mot ion vectors having a vertical direction component of zero on each line of the plurality of blocks divided into a lattice shape. Note that at this time, motion vectors having a horizontal direction component of zero are excluded. When a maximum frequency value is equal to or greater than a predetermined value on each histogram, it is determined that a horizontal telop (a horizontal telop having a horizontal direction speed that corresponds to the maximum frequency value) exists on the line corresponding to the histogram.

Further, a histogram of the vertical direction component, or in other words the vertical direction speed, is generated in relation to motion vectors having a horizontal direction component of zero on each line of the plurality of blocks. Note that at this time, motion vectors having a vertical direction component of zero are excluded. When the maximum frequency value is equal to or greater than a predetermined value on each histogram, it is determined that a vertical telop (a vertical telop having a vertical direction speed that corresponds to the maximum frequency value) exists on the line corresponding to the histogram.

In this embodiment, the presence and speed of the telop is detected by analyzing motion vector information statistically, but the method of detecting the telop and the speed thereof is not limited thereto. For example, the telop and the speed thereof may be detected using pixel data of an input frame image, a characteristic value relating to inter-frame difference data, both the pixel data and the characteristic value, and so on.

The telop detection unit 3 outputs an array Vx and an array Vy having a number of elements corresponding to the number of lines formed by the plurality of blocks as telop detection information. Each element of the array Vx corresponds to a line of the plurality of blocks, and on a line determined to have a horizontal telop, the speed (horizontal direction speed) thereof is set as the element, whereas zero is set as the element on a line not having a horizontal telop. Further, each element of the array Vy corresponds to a line of the plurality of blocks, and on a line determined to have a vertical telop, the speed (vertical direction speed) thereof is set as the element, whereas zero is set as the element on a line not having a vertical telop.

The telop detection information (the arrays Vx, Vy) is output to the selection unit 4, the first correction unit 5, and the second correction unit 6.

The first correction unit 5 and the second correction unit 6 correct the array Vec. More specifically, the first correction unit 5 corrects the motion vector of a block having a horizontal telop, from among the plurality of blocks. The second correction unit 6 corrects the motion vector of a block having a vertical telop, from among the plurality of blocks. Processing performed by the first correction unit 5 and second correction unit 6 will be described in detail below.

On the basis of the telop detection information obtained from the telop detection unit 3, the selection unit 4 determines that the correction processing of the first correction unit 5 is to be performed alone, that the correction processing of the second correction unit 6 is to be performed alone, or that neither the correction processing of the first correction unit 5 nor the correction processing of the second correction unit 6 is to be performed. More specifically, the selection unit 4 selects the horizontal telop (horizontal direction) when only the correction processing of the first correction unit 5 is to be performed and selects the vertical telop (vertical direction) when only the correction processing of the second correction unit 6 is to be performed. When neither the correction processing of the first correction unit 5 nor the correction processing of the second correction unit 6 is to be performed, the selection unit 4 does not select a telop (direction). The processing of the selection unit 4 will be described in detail below.

The switches 7, 8 control the first correction unit and the second correction unit 6 on the basis of the detection result obtained by the telop detection unit 3. In this embodiment, the first correction unit 5 and second correction unit 6 are controlled by switching an inter-function connection in accordance with the selection result (a selection result based on the detection result of the telop detection unit 3) obtained by the selection unit 4.

More specifically, when a telop is not selected by the selection unit 4, the inter-function connection is switched such that the array Vec output from the motion vector detection unit 2 is input into the interpolated frame generation unit 9 as is. In other words, the first correction unit 5 and second correction unit 6 are controlled such that correction is not performed by the first correction unit 5 and second correction unit 6.

When the horizontal telop is selected by the selection unit 4, the inter-function connection is switched such that the array Vec output from the motion vector detection unit 2 is input into the interpolated frame generation unit 9 after being corrected by the first correction unit 5. In other words, the first correction unit 5 and second correction unit 6 are controlled such that correction is performed by the first correction unit 5 but the correction of the second correction unit 6 is omitted.

When the vertical telop is selected, the inter-function connection is switched such that the array Vec output from the motion vector detection unit 2 is input into the interpolated frame generation unit 9 after being corrected by the second correction unit 6. In other words, the first correction unit 5 and second correction unit 6 are controlled such that correction is performed by the second correction unit 6 but the correction of the first correction unit 5 is omitted.

The interpolated frame generation unit 9 generates an interpolated frame using the motion vector of each block. More specifically, the interpolated frame generation unit 9 generates an interpolated frame using the array Vec (or the corrected array Vec) and the two frames (the frames F1, F2) to the front and rear of the generated interpolated frame.

(Specific Example of Processing Performed by Selection Unit)

A specific example of the processing performed by the selection unit 4 will now be described.

When the elements of the array Vx and the array Vy are all zero (when no horizontal telops and vertical telops are detected), the selection unit 4 does not select a telop.

When a non-zero element is included in only one of the array Vx and the array Vy (when either a horizontal telop or a vertical telop is detected), the detected telop is selected.

When a non-zero element is included in both the array Vx and the array Vy (when both a horizontal telop and a vertical telop are detected), one of the telops is selected.

A large effect (interpolation effect) is obtained by depicting the movement of a high-speed telop smoothly, and therefore, in this embodiment, the selection unit 4 selects the telop having the higher speed when both a horizontal telop and a vertical telop are detected by the telop detection unit 3.

For example, the speed of the horizontal telop and the speed of the vertical telop are compared with respective predetermined thresholds to determine whether the respective telops are high speed or low speed. When one of the telops is determined to be high speed, that telop (the telop determined to be high speed) is selected. Further, since horizontal direction movement is easier to follow than vertical direction movement, meaning that a greater interpolation effect can be expected from depicting the movement of a horizontal telop smoothly, the horizontal telop is selected when identical determination results are obtained in relation to both telops.

More specifically, when a speed Vx_t of the horizontal telop is equal to or higher than a predetermined threshold Vxth (when the horizontal telop is determined to be high speed), the horizontal telop is selected regardless of a speed Vy_t of the vertical telop. When the speed Vx_t of the horizontal telop is lower than the threshold Vxth and the speed Vy_t of the vertical telop is equal to or higher than a predetermined threshold Vyth (when the horizontal telop is determined to be low speed and the vertical telop is determined to be high speed), the vertical telop is selected. When the speed Vx_t of the horizontal telop is lower than the threshold Vxth and the speed Vy_t of the vertical telop is lower than the threshold Vyth (when both the horizontal telop and the vertical telop are determined to be low speed), the horizontal telop is selected.

Note that when a plurality of non-zero elements are included in the array Vx (when a plurality of lines having a horizontal telop are detected), a maximum value Max (Vx) of these elements is preferably compared to the threshold Vxth (since a steadily greater interpolation effect is obtained as the movement speed increases). Likewise, when a plurality of non-zero elements are included in the array Vy, a maximum value Max (Vy) of these elements is preferably compared to the threshold Vyth. In so doing, telop selection can be performed appropriately even when a plurality of horizontal telops or vertical telops exist, for example. Needless to say, an average value or a cumulative value of the non-zero elements included in the array or the like may be compared to the threshold.

These selection methods are summarized in Table 1. Note that in Table 1, “*” denotes an arbitrary value other than zero while “−” indicates that a non-zero element does not exist in the array.

TABLE 1

| PRESENCE | PRESENCE | SPEED | SPEED | |
|---|---|---|---|---|
| OF | OF | OF | OF | |
| HORIZONTAL | VERTICAL | HORIZONTAL | VERTICAL | SELECTION |
| TELOP | TELOP | TELOP | TELOP | RESULT |
| NO | NO | — | — | NONE |
| YES | NO | * | — | HORIZONTAL |
| | | | | TELOP |
| NO | YES | — | * | VERTICAL |
| | | | | TELOP |
| YES | YES | Vx_t ≧ Vxth | * | HORIZONTAL |
| | | | | TELOP |
| YES | YES | Vx_t < Vxth | Vy_t ≧ Vyth | VERTICAL |
| | | | | TELOP |
| YES | YES | Vx_t < Vxth | Vy_t < Vyth | HORIZONTAL |
| | | | | TELOP |

Since a greater interpolation effect can be expected from depicting the movement of a horizontal telop smoothly, the threshold Vxth is preferably smaller than the threshold Vyth. For example, threshold Vxth=five pixels/frame and threshold Vyth=eight pixels/frame or the like may be set. Note, however, that the thresholds are to be set appropriately by a manufacturer or user and are not limited to these values.

(Specific Example of Processing Performed by First Correction Unit and Second Correction Unit)

A specific example of the processing performed by the first correction unit 5 and the second correction unit 6 will now be described.

The first correction unit 5 detects a block, from among the blocks belonging to the line of the array Vx that includes a non-zero element (i.e. the line including a horizontal telop), in which the vertical direction component is zero and the horizontal direction component matches the speed of the detected horizontal telop as the block including the horizontal telop. Further, the first correction unit 5 regards adjacent blocks (a total of eight blocks adjacent in the vertical direction, the horizontal direction, and diagonal directions) to the detected block as blocks including a horizontal telop and corrects the motion vectors of these blocks (corrects the array Vec). More specifically, the first correction unit 5 sets the vertical direction component of the motion vector at zero and replaces the horizontal direction component with the speed of the detected horizontal telop.

When this correction processing has been performed on all of the lines considered to include a horizontal telop, the first correction unit 5 outputs the corrected array Vec to the interpolated frame generation unit 9.

The reason why the blocks adjacent to the detected block are regarded as blocks including a horizontal telop is that an area of the horizontal telop in these blocks is small and therefore the likelihood of detecting a different motion vector to the movement speed of the horizontal telop is high. By regarding these blocks as blocks including a horizontal telop, partial chipping of the horizontal telop (corruption of the horizontal telop) in the interpolated frame can be suppressed.

The second correction unit 6 detects a block, from among the blocks belonging to the line of the array Vy that includes a non-zero element (i.e. the line including a vertical telop), in which the horizontal direction component is zero and the vertical direction component matches the speed of the detected vertical telop as the block including the vertical telop. Further, the second correction unit 6 regards the adjacent blocks to the detected block as blocks including a vertical telop and corrects the motion vectors of these blocks (corrects the array Vec). More specifically, the second correction unit 6 sets the horizontal direction component of the motion vector at zero and replaces the vertical direct ion component with the speed of the detected vertical telop.

When this correction processing has been performed on all of the lines considered to include a vertical telop, the second correction unit 6 outputs the corrected array Vec to the interpolated frame generation unit 9.

When the input video image includes both a horizontal telop and a vertical telop, a block that includes both telops may exist. In a case where the telops overlap in this type of block, the motion vector of a telop (an upper side telop) displayed on the upper side of the telops is detected as the motion vector of the block (an overlapping block). Hence, as long as the upper side telop is selected by the selection unit 4, an interpolated frame that does not disturb the upper side telop can be generated.

However, the selection unit 4 does not always select the upper side telop. When the selection unit 4 selects a different telop (i.e. the telop displayed on a lower side; a lower side telop) to the upper side telop, the upper side telop is disturbed in the interpolated frame. More specifically, the motion vector of the lower side telop is allocated as the motion vector of the block including the upper side telop (the aforementioned overlapping block and the adjacent blocks thereto), and as a result, the upper side telop is disturbed in the interpolated frame.

Therefore, the first correction unit 5 and second correction unit 6 preferably do not correct the motion vector of a block that includes both a horizontal telop and a vertical telop. With this constitution, interpolation can be applied favorably to (telop disturbance such as that described above can be suppressed in) a region where a horizontal telop and a vertical telop overlap.

### Second Embodiment

### Overall Constitution

Next, a second embodiment of the present invention will be described. The basic constitution of an image processing apparatus according to this embodiment is identical to that of the first embodiment (FIG. 1), and therefore description thereof has been omitted and only parts that are different to the first embodiment (specifically, the processing of the selection unit 4) will be described below.

### (Specific Example of Processing Performed by Selection Unit)

A specific example of the processing performed by the selection unit 4 will be described below. Note that the processing performed by the selection unit 4 when all of the elements in the array Vx and the array Vy are zero and when a non-zero element is included in only one of the array Vx and the array Vy is similar to that of the first embodiment and therefore description of this processing has been omitted.

A large-sized telop is visually conspicuous, and therefore a large interpolation effect can be expected in relation to this type of telop. Hence, in this embodiment, when the telop detection unit 3 detects both a horizontal telop and a vertical telop, the selection unit 4 selects the telop having the larger size.

For example, the size of the horizontal telop and the size of the vertical telop are compared with respective predetermined thresholds to determine whether the respective telops are large or small. When one of the telops is determined to be large, that telop (the telop determined to be large) is selected. Further, since a greater interpolation effect can be expected from depicting the movement of a horizontal telop smoothly, the horizontal telop is selected when identical determination results are obtained in relation to both telops.

More specifically, when a size Sx of the horizontal telop is equal to or larger than a predetermined threshold Sxth (when the horizontal telop is determined to be large), the horizontal telop is selected regardless of a size Sy of the vertical telop. When the size Sx of the horizontal telop is smaller than the threshold Sxth and the size Sy of the vertical telop is equal to or larger than a predetermined threshold Syth (when the horizontal telop is determined to be small and the vertical telop is determined to be large), the vertical telop is selected. When the size Sx of the horizontal telop is smaller than the threshold Sxth and the size Sy of the vertical telop is smaller than the threshold Syth (when both the horizontal telop and the vertical telop are determined to be small), the horizontal telop is selected.

These selection methods are summarized in Table 2. Note that in Table 2, “*” denotes an arbitrary value other than zero while “−” indicates that a non-zero element does not exist in the array.

TABLE 2

| PRESENCE | | SIZE | SIZE | |
|---|---|---|---|---|
| OF | PRESENCE OF | OF | OF | |
| HORIZONTAL | VERTICAL | HORIZONTAL | VERTICAL | SELECTION |
| TELOP | TELOP | TELOP | TELOP | RESULT |
| NO | NO | — | — | NONE |
| YES | NO | * | — | HORIZONTAL |
| | | | | TELOP |
| NO | YES | — | * | VERTICAL |
| | | | | TELOP |
| YES | YES | Sx ≧ Sxth | * | HORIZONTAL |
| | | | | TELOP |
| YES | YES | Sx < Sxth | Sy ≧ Syth | VERTICAL |
| | | | | TELOP |
| YES | YES | Sx < Sxth | Sy < Syth | HORIZONTAL |
| | | | | TELOP |

Note that the size of each telop may be determined by analyzing the arrays Vx, Vy. For example, a maximum value of a number of continuous elements having an identical value other than zero in the array Vx may be set as the size Sx of the horizontal telop. Further, a maximum value of a number of continuous elements having an identical value other than zero in the array Vy may be set as the size Sy of the vertical telop.

Note that the method of detecting the size is not limited to this method. For example, a telop may be detected more precisely through character recognition or the like and the size of each character of the telop may be calculated from the detection result. When characters of a plurality of sizes are detected at this time, the largest size is preferably set as the telop size (since larger telops are more visually conspicuous). As long as the size of the telop can be grasped, any value may be set as the size.

Since a greater interpolation effect can be expected from depicting the movement of a horizontal telop smoothly, the threshold Sxth is preferably smaller than the threshold Syth. For example, threshold Sxth=two blocks and threshold Syth=four blocks or the like may be set. Note, however, that the thresholds are to be set appropriately by a manufacturer or user and are not limited to these values.

### Third Embodiment

### Overall Constitution

Next, a third embodiment of the present invention will be described. An image processing apparatus according to this embodiment includes, in addition to the constitution (FIG. 1) of the image processing apparatus according to the first embodiment, a luminance detection unit. Parts that are different to the first embodiment will be described below.

The luminance detection unit calculates an average luminance of each block and outputs the calculated average luminance to the telop detection unit 3 as luminance information. More specifically, the luminance detection unit sets pixel values of pixels included in each block as luminance values of the pixels, and calculates an average value of the pixel values in each block as the average luminance.

The telop detection unit 3 performs the processing described in the first embodiment, and also calculates the luminance of the detected telop. In this embodiment, an array Lx and an array Ly are generated in addition to the arrays Vx, Vy, and the arrays Vx, Vy, Lx, Ly are output as the telop detection information (note that the arrays Lx, Ly may be output to the selection unit 4 alone). Similarly to the arrays Vx, Vy, the elements of the arrays Lx, Ly correspond respectively to the lines of the plurality of blocks.

More specifically, when generating the speed histogram, the telop detection unit 3 calculates, for each speed, a cumulative average luminance value of the blocks corresponding to the speed. Next, the telop detection unit 3 calculates the luminance (average luminance) of the telop by dividing the cumulative average luminance value of the blocks corresponding to the speed of the detected telop (the speed having the maximum frequency on the histogram) by the frequency (the frequency of the corresponding speed on the histogram). The telop detection unit 3 then generates the array Lx, in which lines not including a horizontal telop have zero as an element and lines including a horizontal telop have the luminance of the horizontal telop as an element. The telop detection unit 3 also generates the array Ly, in which lines not including a vertical telop have zero as an element and lines including a vertical telop have the luminance of the vertical telop as an element.

### (Specific Example of Processing Performed by Selection Unit)

A specific example of the processing performed by the selection unit 4 will be described below. Note that the processing performed by the selection unit 4 when all of the elements in the array Vx and the array Vy are zero and when a non-zero element is included in only one of the array Vx and the array Vy is similar to that of the first embodiment and therefore description of this processing has been omitted.

A bright telop is visually conspicuous, and therefore a large interpolation effect can be expected in relation to this type of telop. Hence, in this embodiment, when the telop detection unit 3 detects both a horizontal telop and a vertical telop, the selection unit 4 selects the telop having the higher luminance.

For example, the luminance of the horizontal telop and the luminance of the vertical telop are compared with respective predetermined thresholds to determine whether the respective telops have high luminance or low luminance. When one of the telops is determined to have high luminance, that telop (the telop determined to have high luminance) is selected. Further, since a greater interpolation effect can be expected from depicting the movement of a horizontal telop smoothly, the horizontal telop is selected when identical determination results are obtained in relation to both telops.

More specifically, when a luminance Lx_avg of the horizontal telop is equal to or higher than a predetermined threshold Lxth (when the horizontal telop is determined to have high luminance), the horizontal telop is selected regardless of a luminance Ly_avg of the vertical telop. When the luminance Lx_avg of the horizontal telop is lower than the threshold Lxth and the luminance Ly_avg of the vertical telop is equal to or higher than a predetermined threshold Lyth (when the horizontal telop is determined to have low luminance and the vertical telop is determined to have high luminance), the vertical telop is selected. When the luminance Lx_avg of the horizontal telop is lower than the threshold Lxth and the luminance Ly_avg of the vertical telop is lower than the threshold Lyth (when both the horizontal telop and the vertical telop are determined to have low luminance), the horizontal telop is selected.

Note that when a plurality of non-zero elements are included in the array Lx (when a plurality of lines having a horizontal telop are detected), a maximum value Max (Lx) of these elements is preferably compared to the threshold Lxth (since a steadily greater interpolation effect is obtained as the luminance increases). Likewise, when a plurality of non-zero elements are included in the array Ly, a maximum value Max (Ly) of these elements is preferably compared to the threshold Lyth. In so doing, telop selection can be performed appropriately even when a plurality of horizontal telops or vertical telops exist, for example. Needless to say, an average value or a cumulative value of the non-zero elements included in the array or the like may be compared to the threshold.

These selection methods are summarized in Table 3. Note that in Table 3, “*” denotes an arbitrary value other than zero while “−” indicates that a non-zero element does not exist in the array.

TABLE 3

| PRESENCE | PRESENCE | LUMINANCE | LUMINANCE | |
|---|---|---|---|---|
| OF | OF | OF | OF | |
| HORIZONTAL | VERTICAL | HORIZONTAL | VERTICAL | SELECTION |
| TELOP | TELOP | TELOP | TELOP | RESULT |
| NO | NO | — | — | NONE |
| YES | NO | * | — | HORIZONTAL |
| | | | | TELOP |
| NO | YES | — | * | VERTICAL |
| | | | | TELOP |
| YES | YES | Lx_avg ≧ Lxth | * | HORIZONTAL |
| | | | | TELOP |
| YES | YES | Lx_avg < Lxth | Ly_avg ≧ Lyth | VERTICAL |
| | | | | TELOP |
| YES | YES | Lx_avg < Lxth | Ly_avg < Lyth | HORIZONTAL |
| | | | | TELOP |

Since a greater interpolation effect can be expected from depicting the movement of a horizontal telop smoothly, the threshold Lxth is preferably smaller than the threshold Lyth. For example, assuming that the pixel value is represented by eight bits, threshold Lxth=180 and threshold Lyth=220, where a minimum value is 0 and a maximum value is 255, and so on may be set. Note, however, that the thresholds are to be set appropriately by a manufacturer or user and are not limited to these values.

Note that in this embodiment, the average luminance is calculated as the luminance of the telop using the average luminance of each block, but the method of calculating the luminance of the telop is not limited thereto. For example, a cumulative luminance of each block (a cumulative value of the luminance of the pixels included in each block) may be calculated for use instead of the average luminance of each block. Further, a cumulative luminance (a cumulative value of the luminance of the block corresponding to the speed of the detected telop) may be calculated as the luminance of the telop instead of the average luminance. As long as the luminance of the telop can be grasped, any value may be used as the luminance.

### Fourth Embodiment

### Overall Constitution

Next, a fourth embodiment of the present invention will be described. An image processing apparatus according to this embodiment includes, in addition to the constitution (FIG. 1) of the image processing apparatus according to the first embodiment, a history storage unit. Parts that are different to the first embodiment will be described below.

The history storage unit stores a history of the selection results obtained by the selection unit 4. More specifically, the history storage unit stores selection results obtained by the selection unit 4 during generation of the previous interpolated frame.

(Specific Example of Processing Performed by Selection Unit)

A specific example of the processing performed by the selection unit 4 will now be described. Note that the processing performed by the selection unit 4 when all of the elements in the array Vx and the array Vy are zero and when a non-zero element is included in only one of the array Vx and the array Vy is similar to that of the first embodiment and therefore description of this processing has been omitted.

In this embodiment, when an identical determination result is obtained in relation to the horizontal telop and the vertical telop and correction was performed by the second correction unit 6 during generation of the previous interpolated frame, the selection unit 4 selects the vertical telop instead of the horizontal telop. In other words, the vertical telop is selected when an identical determination result is obtained in relation to the horizontal telop and the vertical telop and the vertical telop was selected during generation of the previous frame.

More specifically, when the speed of the horizontal telop is equal to or higher than the threshold Vxth and the speed of the vertical telop is lower than the threshold Vyth, the horizontal telop is selected regardless of the past selection result. When the speed of the horizontal telop is lower than the threshold Vxth and the speed of the vertical telop is equal to or higher than the threshold Vyth, the vertical telop is selected regardless of the past selection result. When the speed of the horizontal telop is equal to or higher than the threshold Vxth and the speed of the vertical telop is equal to or higher than the threshold Vyth, and when the speed of the horizontal telop is lower than the threshold Vxth and the speed of the vertical telop is lower than the threshold Vyth, the telop is selected on the basis of the past selection result. More specifically, when a telop was selected during generation of the previous interpolated frame, that telop is selected. In other words, if the horizontal telop was selected during generation of the previous interpolated frame, the horizontal telop is selected, and if the vertical telop was selected, the vertical telop is selected. Further, if no telop was selected during generation of the previous interpolated frame, the horizontal telop is selected.

These selection methods are summarized in Table 4. Note that in Table 4, “*” denotes an arbitrary value (element) other than zero or a past selection result, while “−” indicates that a non-zero element does not exist in the array.

TABLE 4

| PRESENCE | PRESENCE | SPEED | SPEED | | |
|---|---|---|---|---|---|
| OF | OF | OF | OF | PAST | |
| HORIZONTAL | VERTICAL | HORIZONTAL | VERTICAL | SELECTION | SELECTION |
| TELOP | TELOP | TELOP | TELOP | RESULT | RESULT |
| NO | NO | — | — | * | NONE |
| YES | NO | * | — | * | HORIZONTAL |
| | | | | | TELOP |
| NO | YES | — | * | * | VERTICAL |
| | | | | | TELOP |
| YES | YES | Vx_t ≧ | Vy_t < | * | HORIZONTAL |
| | | Vxth | Vyth | | TELOP |
| YES | YES | Vx_t < | Vy_t ≧ | * | VERTICAL |
| | | Vxth | Vyth | | TELOP |
| YES | YES | Vx_t < | Vy_t < | NONE | HORIZONTAL |
| | | Vxth | Vyth | | TELOP |
| YES | YES | Vx_t < | Vy_t < | HORIZONTAL | HORIZONTAL |
| | | Vxth | Vyth | TELOP | TELOP |
| YES | YES | Vx_t < | Vy_t < | VERTICAL | VERTICAL |
| | | Vxth | Vyth | TELOP | TELOP |
| YES | YES | Vx_t ≧ | Vy_t ≧ | NONE | HORIZONTAL |
| | | Vxth | Vyth | | TELOP |
| YES | YES | Vx_t ≧ | Vy_t ≧ | HORIZONTAL | HORIZONTAL |
| | | Vxth | Vyth | TELOP | TELOP |
| YES | YES | Vx_t ≧ | Vy_t ≧ | VERTICAL | VERTICAL |
| | | Vxth | Vyth | TELOP | TELOP |

Hence, in this embodiment, when both telops are determined to be high speed and when both telops are determined to be low speed, the telop selected in relation to the previous interpolated frame is selected. In so doing, a situation in which the selected telop (the telop to be subjected to smooth movement depiction) changes in each frame can be avoided, and as a result, the operation to depict the movement of the telop smoothly can be performed with stability.

Note that in this embodiment, the telop is selected on the basis of the telop speed and the past selection result, but the telop may be selected on the basis of a combination of the telop size or luminance and the past selection result. More specifically, when both telops are determined to be large (or small) or both telops are determined to have high luminance (or low luminance), the telop selected in relation to the previous interpolated frame may be selected. Further, the speed, size, and luminance of the telop and the past selection result may be combined in any possible form and used to select the telop.

According to the first to fourth embodiments described above, when both a horizontal telop and a vertical telop are detected, the first correction unit 5 and second correction unit 6 are controlled such that motion vector correction is performed by one of the first correction unit 5 and the second correction unit 6 and the correction performed by the other is omitted. Therefore, the movement of the telop can be depicted smoothly using a simple constitution, in which the processing of one of the first correction unit 5 and the second correction unit 6 is omitted, and with a smaller calculation load than that of a case in which correction is performed by both correction units.

Note that in the above embodiments, the choice as to whether to perform correction using the first correction unit 5 or the second correction unit 6 is made on the basis of the speed, size, and luminance of the telop and the past selection result, but the choosing method is not limited thereto, and as long as only one of correction by the first correction unit 5 and correction by the second correction unit 6 is performed when both a horizontal telop and a vertical telop are detected, the correction unit that is to perform correction may be chosen as desired. The correction unit that is to perform correction may be determined in advance or chosen randomly.

In the above embodiments, the first correction unit 5 and the second correction unit 6 replace the motion vector of the block including the telop with the speed of the telop, but the correction method is not limited thereto, and as long as the motion vector of the block including the telop is corrected in a direction approaching the speed of the telop, the movement of the telop can be depicted smoothly.

In the above embodiments, the first correction unit 5 and the second correction unit 6 are controlled by switching the inter-function connection using the switches 7, 8, but as long as the first correction unit 5 and second correction unit 6 can be controlled, any constitution may be employed. For example, the array Vec may be input into the interpolated frame generation unit 9 via the first correction unit 5 and the second correction unit 6 at all times. In this case, a control circuit may be employed to control the first correction unit 5 and the second correction unit 6 such that the input Vec is output either as is or following correction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-256882, filed on Nov. 10, 2009, which is hereby incorporated by reference herein in its entirety.

What is claimed is:

1. An image processing apparatus for converting a frame rate by inserting an interpolated frame between frames of an input video image, comprising:
a motion vector detecting unit which divides the input video image into a plurality of blocks and detects a motion vector of each of the blocks;
a telop detecting unit which detects a horizontal telop that moves in a horizontal direction and a vertical telop that moves in a vertical direction from the input video image;
a first correcting unit which corrects the motion vector of a block that includes the horizontal telop, from among the plurality of blocks;
a second correcting unit which corrects the motion vector of a block that includes the vertical telop, from among the plurality of blocks;
a control unit which controls the first correcting unit and the second correcting unit on the basis of a detection result from the telop detecting unit; and
a generating unit which generates the interpolated frame, using the motion vector of each of the blocks,
wherein, when the telop detecting unit detects both the horizontal telop and the vertical telop, the control unit controls the first correcting unit and the second correcting unit such that correction is performed by one of the first correcting unit and the second correcting unit and correction by the other one of the first correcting unit and the second correcting unit is omitted.

2. The image processing apparatus according to claim 1, further comprising a selecting unit which selects a telop having a higher speed when the telop detecting unit detects both the horizontal telop and the vertical telop,
wherein the control unit controls the first correcting unit and the second correcting unit such that correction is performed by the first correcting unit when the selecting unit selects the horizontal telop, and correction is performed by the second correcting unit when the selecting unit selects the vertical telop.

3. The image processing apparatus according to claim 1, further comprising a selecting unit which selects a telop having a larger size when the telop detecting unit detects both the horizontal telop and the vertical telop,
wherein the control unit controls the first correcting unit and the second correcting unit such that correction is performed by the first correcting unit when the selecting unit selects the horizontal telop, and correction is performed by the second correcting unit when the selecting unit selects the vertical telop.

4. The image processing apparatus according to claim 1, further comprising a selecting unit which selects a telop having a higher luminance when the telop detecting unit detects both the horizontal telop and the vertical telop,
wherein the control unit controls the first correcting unit and the second correcting unit such that correction is performed by the first correcting unit when the selecting unit selects the horizontal telop, and correction is performed by the second correcting unit when the selecting unit selects the vertical telop.

5. The image processing apparatus according to claim 2, wherein, the selecting unit compares a speed of the horizontal telop as well as a speed of the vertical telop with respective predetermined thresholds to determine whether the respective telops have a high speed or a low speed,
when one of the telops is determined to have a high speed, selects the high-speed telop, and
when an identical determination result is obtained in relation to both of the telops, selects the horizontal telop.

6. The image processing apparatus according to claim 3, wherein, the selecting unit compares a size of the horizontal telop as well as a size of the vertical telop with respective predetermined thresholds to determine whether the respective telops have a large size or a small size,
when one of the telops is determined to have a large size, selects the large-sized telop, and
when an identical determination result is obtained in relation to both of the telops, selects the horizontal telop.

7. The image processing apparatus according to claim 4, wherein, the selecting unit compares a luminance of the horizontal telop as well as a luminance of the vertical telop with respective predetermined thresholds to determine whether the respective telops have a high luminance or a low luminance,
when one of the telops is determined to have a high luminance, selects the high-luminance telop, and
when an identical determination result is obtained in relation to both of the telops, selects the horizontal telop.

8. The image processing apparatus according to claim 5, wherein, in a case where an identical determination result is obtained in relation to both of the telops and also in a case where correction has been performed by the second correcting unit when generating a previous interpolated frame, the selecting unit selects the vertical telop instead of the horizontal telop.

9. The image processing apparatus according to claim 1, wherein the first correcting unit and the second correcting unit do not correct the motion vector of a block including both the horizontal telop and the vertical telop.

10. An image processing method for converting a frame rate by inserting an interpolated frame between frames of an input video image,
the method comprising:
a motion vector detecting step of dividing the input video image into a plurality of blocks and detecting a motion vector of each of the blocks;
a telop detecting step of detecting a horizontal telop that moves in a horizontal direction and a vertical telop that moves in a vertical direction from the input video image;
a first correcting step of correcting the motion vector of a block that includes the horizontal telop, from among the plurality of blocks;
a second correcting step of correcting the motion vector of a block that includes the vertical telop, from among the plurality of blocks;
a control step of controlling processing performed in the first correcting step and the second correcting step on the basis of a detection result from the telop detecting step; and
a generating step of generating the interpolated frame, using the motion vector of each of the blocks,
wherein, when both the horizontal telop and the vertical telop are detected in the telop detecting step, the processing performed in the first correcting step and the second correcting step is controlled in the control step such that correction is performed in one of the first correcting step and the second correcting step, and correction is omitted in the other one of the first correcting step and the second correcting step.

11. The image processing method according to claim 10, further comprising a selecting step of selecting a telop having a higher speed when both the horizontal telop and the vertical telop are detected in the telop detecting step,
wherein the processing of the first correcting step and the second correcting step is controlled in the control step such that correction is performed in accordance with the first correcting step when the horizontal telop is selected in the selecting step, and correction is performed in accordance with the second correcting step when the vertical telop is selected in the selecting step.

12. The image processing method according to claim 10, further comprising a selecting step of selecting a telop having a larger size when both the horizontal telop and the vertical telop are detected in the telop detecting step,
wherein the processing in the first correcting step and the second correcting step is controlled in the control step such that correction is performed in accordance with the first correcting step when the horizontal telop is selected in the selecting step, and correction is performed in accordance with the second correcting step when the vertical telop is selected in the selecting step.

13. The image processing method according to claim 10, further comprising a selecting step of selecting a telop having a higher luminance when both the horizontal telop and the vertical telop are detected in the telop detecting step,
wherein the processing in the first correcting step and the second correcting step is controlled in the control step such that correction is performed in accordance with the first correcting step when the horizontal telop is selected in the selecting step, and correction is performed in accordance with the second correcting step when the vertical telop is selected in the selecting step.

14. The image processing method according to claim 11, wherein, in the selecting step, a speed of the horizontal telop and a speed of the vertical telop are compared with respective predetermined thresholds to determine whether the respective telops have a high speed or a low speed,
when one of the telops is determined to have a high speed, the high-speed telop is selected, and
when an identical determination result is obtained in relation to both of the telops, the horizontal telop is selected.

15. The image processing method according to claim 12, wherein, in the selecting step, a size of the horizontal telop and a size of the vertical telop are compared with respective predetermined thresholds to determine whether the respective telops have a large size or a small size,
when one of the telops is determined to have a large size, the large-sized telop is selected, and
when an identical determination result is obtained in relation to both of the telops, the horizontal telop is selected.

16. The image processing method according to claim 13, wherein, in the selecting step, a luminance of the horizontal telop and a luminance of the vertical telop are compared with respective predetermined thresholds to determine whether the respective telops have a high luminance or a low luminance,
when one of the telops is determined to have a high luminance, the high-luminance telop is selected, and
when an identical determination result is obtained in relation to both of the telops, the horizontal telop is selected.

17. The image processing method according to claim 14, wherein, in a case where an identical determination result is obtained in relation to both of the telops and also in a case where correction has been performed in accordance with the second correcting step when generating a previous interpolated frame, the vertical telop is selected in the selecting step instead of the horizontal telop.

18. The image processing method according to claim 10, wherein, in the first correcting step and the second correcting step, the motion vector of a block including both the horizontal telop and the vertical telop is not corrected.
